(19) United States
(12) Patent Application Publication
(10) Pub. No.: US 2007/0248056 A1
(43) Pub. Date: Oct. 25, 2007

(54) APPLICATION MANAGED TRANSITION OF IP CONNECTIONS

(76) Inventors: Shiang Yueng Feng, Colleyville, TX (US); Jie Pan, Plano, TX (US)

Correspondence Address: Shiang Yueng Feng, 3402 Fox Meadows Drive, Colleyville, TX, 76034, US

(21) Appl. No.: 11/738,492

(22) Filed: Apr. 22, 2007

Related U.S. Application Data
(60) Provisional application No. 60/745,407, filed on Apr. 23, 2006.

(51) Int. Cl. H04Q 7/00

(52) U.S. Cl. 370/331

(57) ABSTRACT

The present invention accomplishes smooth transition when the IP address in a mobile terminal changes. This Application Managed Transition of IP Connections solution maintains a stable session between a mobile terminal and a peer computing device before, during and after the mobile terminal roams from the coverage area of a first access point to the coverage area of a second access point.

### REFERENCE TO A PROVISIONAL APPLICATION

This application claims the benefit of U.S. Provisional Application No. 60/745,407 filed Apr. 23, 2006 under U.S.C. 119(e).

### FIELD OF THE INVENTION

This present invention relates to wireless Internet communication systems, and more particularly to method, apparatus and system for IP connection management in a wireless network.

### Definition List

AMT Application Managed Transition
AP Access Point
DHCP Dynamic Host Configuration Protocol
GSM Global System for Mobile communication
IP Internet Protocol
MC Mobile Connection
MCI Mobile Connection Identification
MT Mobile Terminal
MTA Mobile Terminal Application
PA Peer Application
PCD Peer Computing Device
RAM Radio Access Manager
SGW Security Gateway
SCTP Stream Control Transport Protocol
TCP Transmission Control Protocol
UMA Unlicensed Mobile Access
UMTS Universal Mobile Telecommunications System
WLAN Wireless Local Area Network
WMAN Wireless Metropolitan Area Network
Wi-Fi Nick name for WLAN standard IEEE 802.11
WiMAX Worldwide Interoperability for Microwave Access, IEEE 802.16

### References

UMA Technology Specifications, UMA Stage 1, UMA Stage 2 and UMA Stage 3, are available at http://www.umatechnology.org;

Mobile IP, IETF RFC 2002, 2290, 2794;

Stream Control Transmission Protocol (SCTP), IETF RFC 2960, 3309.

### BACKGROUND OF THE INVENTION

Unlicensed Mobile Access (UMA) technology utilizes unlicensed spectrum technology, including Wi-Fi, as radio access and allows a mobile terminal (MT), such as a cellular phone, to roam between Global System for Mobile Communication (GSM) or Universal Mobile Telecommunications System (UMTS) network and wireless Internet Protocol (IP) network. UMA radio base stations are called Access Points (AP) and generally have an associated Dynamic Host Configuration Protocol (DHCP) server functionality to dynamically assign an Internet Protocol (IP) address in the private IP sub-network that the DHCP server manages to an MT in the radio coverage area of the AP. The MT uses this IP address to establish a Transmission Control Protocol (TCP) connection with the Security Gateway (SGW) function of the UMA Network Controller to access the GSM or UMTS network. However, current UMA technology specifications do not address roaming between two Wi-Fi APs where the target AP belongs to a different IP sub-network. When the MT changes to a new AP in a different IP sub-network, the old IP address is no longer effective and therefore the old TCP connection with the SGW must be disconnected. After the MT obtains an IP address from the DHCP server associated with the target AP, a new TCP connection with the SGW can then be established. During this transition period, MT access to the GSM or UMTS network is interrupted.

One technique designed to handle this situation is Mobile IP which provides continued services after the IP address changes. In Mobile IP, all traffic to the MT is delivered by the Home Agent in a tunnel via the Foreign Agent serving the MT. However, the great majority of commercial Wi-Fi APs do not implement this necessary Foreign Agent functionality. In addition, the triangle routing approach increases home network traffic and is not suitable for time sensitive applications.

Another technique is the Stream Control Transmission Protocol's Dynamic Address Reconfiguration feature which allows adding and deleting associations with different IP addresses. But the IP address of the association embedded in the ASCONF Chunk is not reachable if it belongs to a private sub-network behind a Network Address Translation (NAT) device commonly used by Wi-Fi APs. Furthermore, different Wi-Fi APs may manage their own private sub-networks identified by the same factory configured value and may assign the same private IP address to the MT. In this case, the routing mechanism in the MT has difficulty selecting the correct network interface device based on the identical local IP address and the Dynamic Address Reconfiguration feature in the peer computing device cannot distinguish the differences between two identical IP addresses assigned to the same MT.

As telecommunication operators plan to embrace Worldwide Interoperability for Microwave Access (WiMAX) technology to bring wide area radio resources to the IP infrastructure, the mobile network is becoming an all IP network. An IP capable WiMAX radio base station is also called an Access Point hereafter. An MT roaming between Wi-Fi and WiMAX APs faces the same problem stemmed from the new IP address assigned by the DHCP server associated with the target AP because the Wi-Fi and WiMAX Access Points will mostly be in two different IP sub-networks.

The present invention describes an Application Managed Transition (AMT) of IP Connections solution to achieve smooth transition at the application layer and associated enhancements in the IP routing layer when an MT roams to the radio coverage area of a target AP.

### SUMMARY OF THE INVENTION

The MT capable of AMT described hereafter has one or more radio air interfaces for accessing different wireless IP networks, for example, Wi-Fi and WiMAX. The MT can concurrently communicate with at least two APs via the same radio air interface if the target AP is of the same kind as the current AP (i.e., between two Wi-Fi or two WiMAX access points) or via two different radio air interfaces if the target AP is of a different kind from the current AP (i.e., between one Wi-Fi and one WiMAX access points). A Radio Access Manager (RAM) running in the MT manages the radio access through these radio air interfaces. The RAM informs a Mobile Terminal Application (MTA) running in the MT when a new IP address is obtained from a newly associated AP and when the radio signal strength from an already associated AP is reduced to a warning level. Incoming application data from all associated APs are delivered through the radio air interfaces to the MTA for further processing. The MTA instructs the serving radio air interface to send out-going application data to the destination through the desired AP.

An MT capable of AMT is in the coverage area of a first AP. The RAM running in the MT obtains a first IP address from the DHCP server associated with the first AP. The RAM informs an MTA running in the MT the availability of the first IP address associated with the first AP. The MTA instructs the IP Routing Module to establish a first IP connection with a Peer Application (PA) running in the Peer Computing Device (PCD) through the first AP using the first IP address associated with the first AP via the first associated radio air interface. The MTA and the PA agree on using a unique Mobile Connection Identification (MCI) to represent the Mobile Connection (MC), which now consists of one first IP connection, between the MTA and the PA. The MTA and the PA start using the first IP connection in exchanging application data. When the MT roams into the coverage area of a second AP and is still under coverage of the first AP, the RAM obtains a second IP address from the DHCP server associated with the second AP. The RAM informs the MTA the availability of the second IP address associated with the second AP. The MTA instructs the IP Routing Module to establish a second IP connection with the PA using the second IP address associated with the second AP via the second associated radio air interface. The MTA provides the MCI through the second IP connection for the PA to associate the second IP connection with the first IP connection. The MTA and the PA coordinate the change to using the second IP connection to exchange application data. The MTA then closes the first IP connection. The MT releases the first IP address before roaming out of the coverage area of the first AP. The IP connection between MTA and PA is thus maintained at the application layer during the time the MT roams from the first AP to the second AP without interruption.

### BRIEF DESCRIPTION OF THE DRAWINGS

FIG. 1 illustrates the components of an MT capable of AMT and radio links between the MT and different APs.

FIG. 2 illustrates the IP connection between the MT and the PCD when the MT is in the coverage area of the first AP.

FIG. 3 illustrates two concurrent IP connections between the MT and the PCD while the MT is in an area covered by both first and second APs.

FIG. 4 illustrates the surviving IP connection between the MT and the PCD when the MT roams to the coverage area of the second AP.

FIG. 5 is the AMT sequence diagram among network elements.

FIG. 6 illustrates the Radio Access Management procedure.

FIG. 7 illustrates AP Identification based air interface selection method.

FIG. 8 illustrates PA Connection Association procedure.

FIG. 9 illustrates AMT related IP Routing Module procedures.

### DETAILED DESCRIPTION OF THE INVENTION

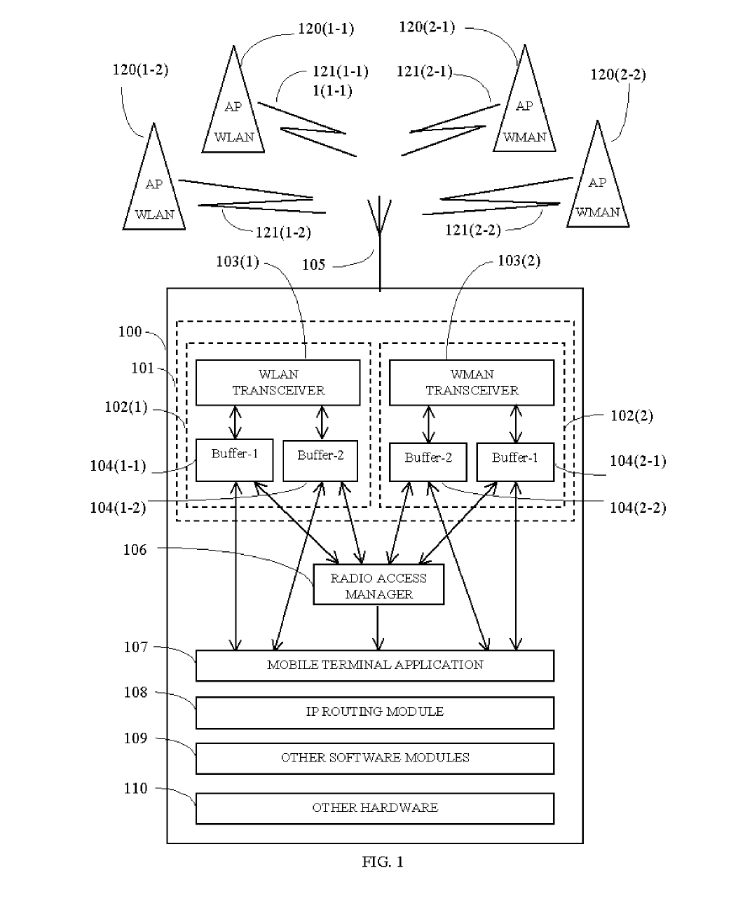

Refer to FIG. 1 for the descriptions on components in an MT to achieve AMT, where arrowed lines represent data flow directions. MT 100 has radio air interface circuitry 101 which contains two radio air interfaces 102 to access two different kinds of wireless IP networks. For example, radio air interface 102(1) is for accessing Wireless Local Area Network (WLAN) such as Wi-Fi and radio air interface 102(2) is for Wireless Metropolitan Area Network (WMAN) such as WiMAX. Each radio air interface 102 contains one Transceiver 103 and two input-output Buffers 104 where WLAN Buffer-1 04(1-1) is for caching data being communicated with a first WLAN AP, WLAN Buffer-2 104(1-2) is for a second WLAN AP, WMAN Buffer-1 104(2-1) is for a first WMAN AP and WMAN Buffer-2 104(2-2) is for a second WMAN AP. Transceiver 103 can communicate with two AP 120 concurrently through antenna 105 via radio links 121. For example, AP 120(1-1) and AP 120(1-2) are of WLAN while AP 120(2-1) and AP 120(1-2) are of WLAN. MT 100 also executes software modules RAM 106, MTA 107, IP Routing Module 108 and other software modules 109 such as operating system and user interface. In addition, other hardware 110 such as memory and keypad are also included in MT 100.

Radio access data packets such as radio signal strength indication and DHCP messages are exchanged between AP 120 and RAM 106 via antenna 105, transceiver 103 and input-output Buffer 104. Other application data packets either destined to or originated from MTA 107 flow through AP 120 via antenna 105, transceiver 103 and input-output Buffer 104. For example, radio access data packets emitted by WLAN AP 120(1-1) travels through radio link 121 (1-1), antenna 105, received by WLAN Transceiver 103(1), cached in Buffer 104(1-1) and delivered to RAM 106 for processing. RAM 106 can send DHCP Request message to the DHCP server associated with WLAN AP 120(1-1) via Buffer 104(1-1), WLAN Transceiver 103(1), antenna 105, radio link 121 (1-1), and WLAN AP 120(1-1). The DHCP ACK message from the DHCP server traverses in the reverse order via WLAN AP 120(1-1), radio link 121(1-1), antenna 105, WLAN Transceiver 103(1) and Buffer 104(1-1) to RAM 106. Incoming application data packets travel through WLAN AP 120(1-1), radio link 121 (1-1), antenna 105, WLAN Transceiver 103(1) and Buffer 104(1-1) to MTA 107 for further processing. MTA 107 sends out-going application data packets through Buffer 104(1-1), WLAN Transceiver 103(1), antenna 105, radio link 121 (1-1) and WLAN AP 120(1-1).

At all times, RAM 106 maintains the one-to-one mapping of AP 120 with its AP Identification to a dedicated input-output Buffer 104 in a radio air interface 102.

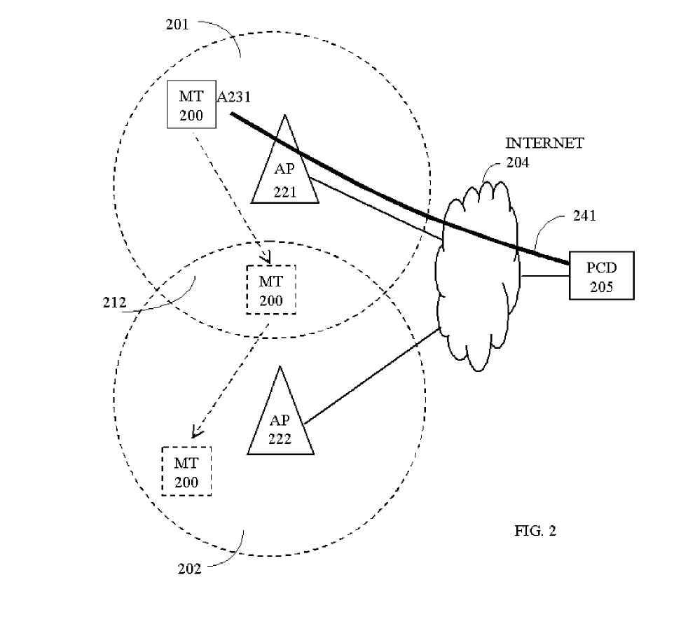

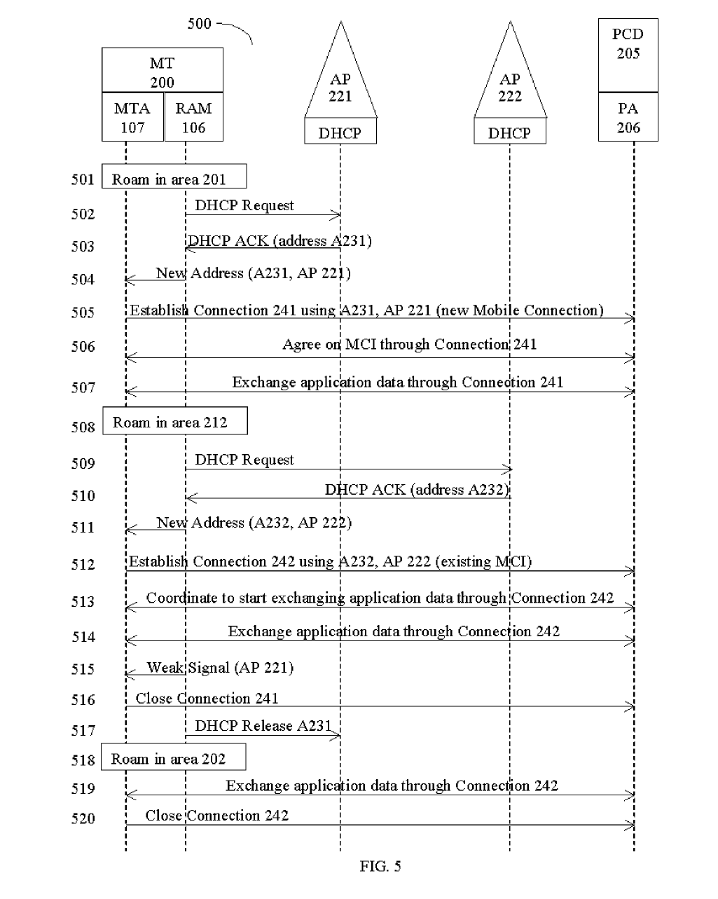

FIGS. 2, 3 and 4 illustrate an MT's concurrent utilization of two or more APs to achieve AMT. AP 221, AP 222 and PCD 205 are connected to the Internet 204. Dashed arrow lines represent an MT's motion in the coverage areas of two neighboring APs, from area 201 covered only by AP 221 through overlapped area 212 covered by both AP221 and AP 222 to area 202 covered only by AP 222. Sequences mentioned in FIGS. 2, 3 and 4 are consolidated in FIG. 5.

Refer to FIG. 2. When MT 200 is in the coverage area 201 of a first AP 221, MT 200 obtains via DHCP a first IP address A231 associated with first AP 221. The MTA 107 (not shown in FIG. 2, to be shown in FIG.5) running in MT 200 instructs the IP Routing Module 1 08 to use the first IP address A231 to make a first IP connection 241 through first AP 221 with a PA 206 (not shown in FIG. 2, to be shown in FIG.5) running in the PCD 205. The MTA 107 and the PA 206 agree on using a unique Mobile Connection Identification (MCI) to represent this newly established first IP connection 241. Then the MTA 107 and the PA 206 use the first IP connection 241 to exchange application data. The first IP connection 241 through AP 221 at this time is the one and only and active conduit in the Mobile Connection represented by the MCI.

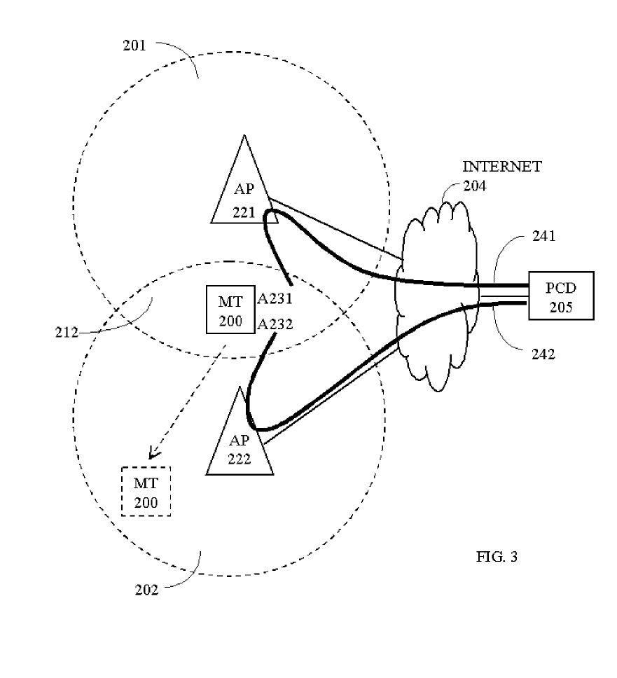

Refer to FIG. 3. When MT 200 roams into area 212 which is still covered by the first AP 221 but also in the coverage area of a second AP 222, MT 200 obtains via DHCP a second IP address A232 from the second AP 222. The MTA 107 then instructs the IP Routing Module 108 to use the second IP address A232 associated with the second AP 222 to make a second IP connection 242 through the second AP 222 with the PA 206 running in PCD 205. At this time, the Mobile Connection represented by the MCI has 2 conduits, the first IP connection 241 through AP 221 and the second IP connection 242 through A222. The first IP connection 241 is the active conduit.

The MTA 107 then sends the MCI through the second IP connection 242 to the PA 206 to declare that the second IP connection 242 is a conduit of the Mobile Connection represented by the MCI. The PA 206 uses the MCI to associate the second IP connection 242 with the first IP connection 241. The MTA 107 and the PA 206 coordinate the change to using the second IP connection 242 in exchanging application data. The second IP connection 242 now becomes the active conduit.

At this time, some application data might still be traveling in the first IP connection 241 toward their destinations. The MTA 107 waits for a finite time interval before closing the first IP connection 241 to allow any data in this conduit to reach their destinations. This algorithm ensures delivery of application data during the transition from the first IP connection 241 to the second IP connection 242.

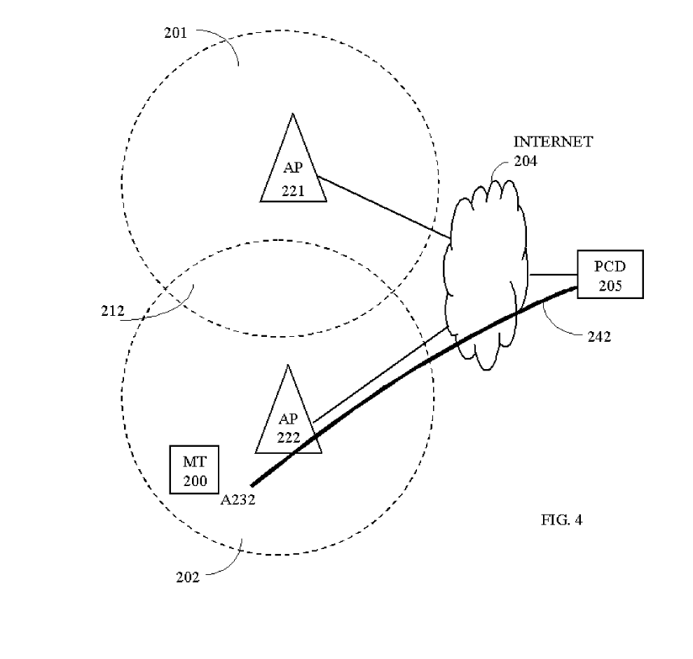

Refer to FIG. 4. Before leaving area 212 covered by both AP 221 and AP 222 and moving toward area 202 covered only by AP 222, MT 200 closes the first IP connection and releases the first IP address A231 associated with the first AP 221. By this time, the second IP connection 242 through AP 222 is the one and only and active conduit in the MC represented by the MCI. When finished exchanging application data in area 202, the MTA 107 and the PA 206 coordinate to close the second IP connection 242. The MC represented by the MCI contains no IP connections and is considered closed. As MT 200 roams away from the second AP 222, MT 200 releases the second IP address A232 from the second AP 222.

FIG. 5 summarizes sequences of actions by components in MT 200, AP 221, AP 222 and PCD 205 to achieve Application Managed Transition of IP Connections.

Sequence 501. MT 200 roams in AP 221 coverage area 201.

Sequence 502. RAM 106 in MT 200 sends DHCP Request message to the DHCP server function associated with AP 221.

Sequence 503. RAM 106 receives IP address A231 in DHCP ACK message from the DHCP server function associated with AP 221.

Sequence 504. RAM 106 sends New Address message to MTA 107 in MT 200 to inform the new IP address A231 associated with AP 221.

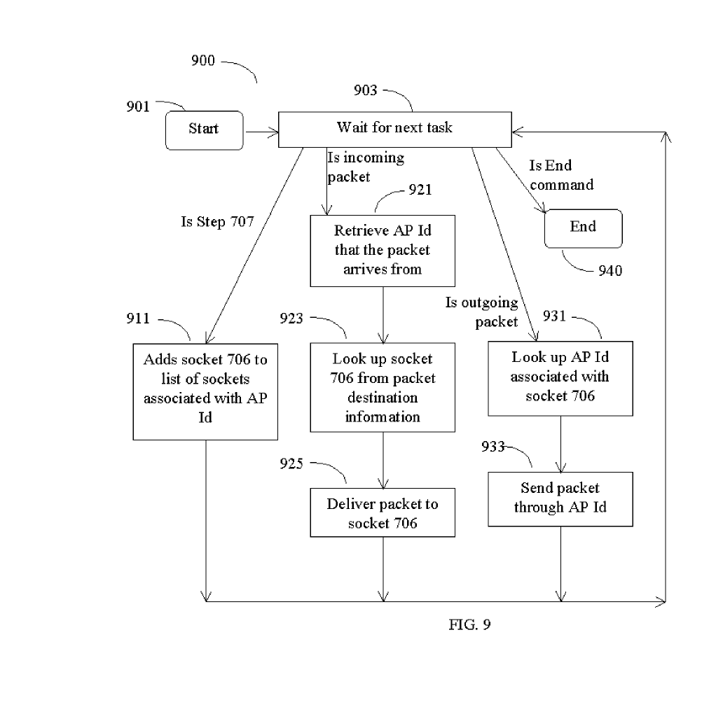

Sequence 505. MTA 107 uses IP address A231 to establish a first IP connection 241 through AP 221 with PA 206 in PCD 205, indicating it is a new Mobile Connection. Procedures for handling incoming and outgoing packets in the IP Routing Module 108 are further described in FIG. 9.

Sequence 506. Through the first IP connection 241, MTA 107 and PA 206 agree on using a unique MCI to represent this Mobile Connection.

Sequence 507. MTA 107 and PA 206 exchange application data through the first IP connection 241 via AP 221.

Sequence 508. MT 200 roams in area 212 covered by both the first AP 221 and the second AP 222.

Sequence 509. RAM 106 sends DHCP Request message to the DHCP server function associated with AP 222.

Sequence 510. RAM 106 receives IP address A232 in DHCP ACK message from the DHCP server function associated with AP 222.

Sequence 511. RAM 106 sends New Address message to MTA 107 to inform the new IP address A232 associated with AP 222.

Sequence 512. MTA 107 uses IP address A232 to establish a second IP connection 242 through AP 222 with PA 206, providing existing MCI through the second IP connection 242 to indicate a new IP connection of an existing Mobile Connection. Procedures for handling incoming and outgoing packets in the IP Routing Module 108 are further described in FIG. 9.

Sequence 513. MTA 107 and PA 206 coordinate the change to start exchanging application data through the second IP connection 242 via AP 222.

Sequence 514. MTA 107 and PA 206 exchange application data through the second IP connection 242 via AP 222.

Sequence 515. RAM 106 detects and notifies MTA 107 the weakening radio signal strength from AP 221.

Sequence 516. MTA 107 closes the first IP connection 241 associated with AP 221.

Sequence 517. RAM 106 sends DHCP Release message to the DHCP server function associated with AP 221 to release address A231.

Sequence 518. MT 200 roams in area 202, covered only by the second AP 222.

Sequence 519. MTA 107 and PA 206 continue to exchange application data through the second IP connection 242 via AP 222.

Sequence 520. After finishing the exchange of application data, MTA 107 closes the second IP connection 242 associated with AP 222.

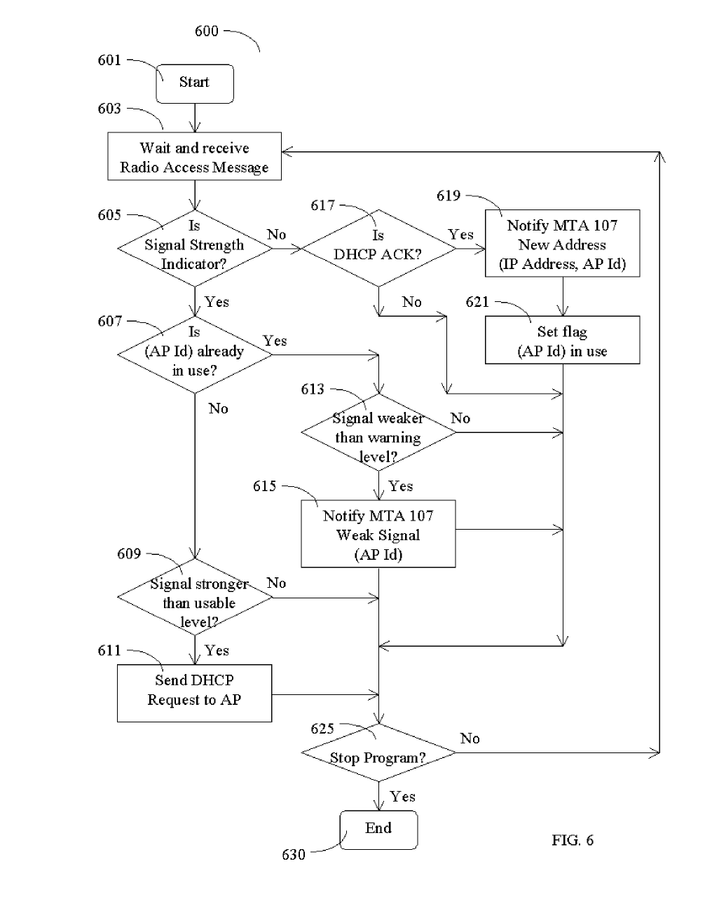

FIG. 6 further describes the Radio Access Management procedure 600 used in RAM 106. Radio Access Management procedure 600 starts 601, waits and receives radio access messages 603. If the received radio access message is radio signal strength indicator 605, check further if the AP Identification is already in use 607. When AP Identification is not in use, check the signal strength against usable level 609. If the signal strength is stronger than usable level, then send a DHCP Request message to AP 611. Otherwise, ignore the message of signal strength not stronger than usable level. Either way, if not to stop the program 625, continue to wait and receive radio access messages 603. If the AP Identification is already in use 607, check the signal strength against warning level 613. If the signal strength is weaker than warning level, then notify MTA 107 with a Weak Signal message 615 to, providing the AP Identification for further processing by MTA 107. When the radio access message is not signal strength indicator 605, check if it is a DHCP ACK message 617. If so, retrieve the IP address in the DHCP ACK message and notify MTA 107 with a New Address message 619, providing the new IP address and the associated AP Identification for further processing by MTA 107. Then, set a flag meaning the AP of given Identification is in use 621 with dedicated input-output Buffer 104 and transceiver 103.

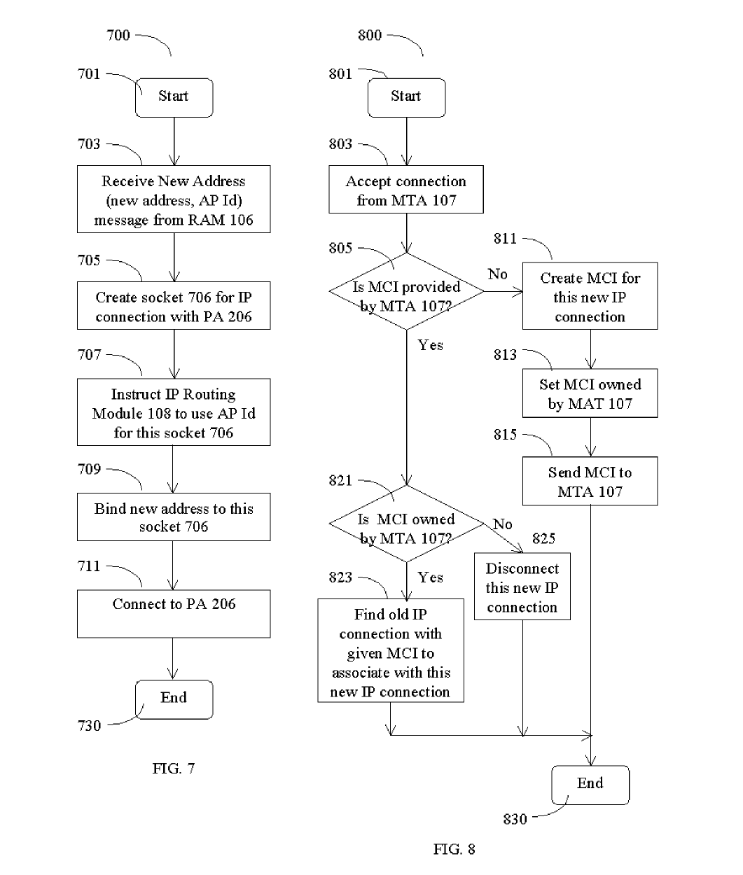

Refer to FIG. 7 for the air interface selection method 700. Because each AP manages its own private sub-network, it is important to recognize that different APs may be configured with the same sub-network identification. For example, APs manufactured by a particular vendor are configured by default to manage the same sub-network of 192.168.1/24. Under this circumstance, two different APs may provide the same IP address value and default gateway value in the DHCP ACK message to the MT. In addition, the destination IP address of the PCD is the same for both intended connections. Conventional IP routing mechanism would select the same route associated with the same AP's air interface to deliver the data, defeating the purpose of utilizing both AP paths. Using the air interface selection method 700, MTA 107 associates the application with the air interface directly to overcome the limitation of conventional IP routing mechanism.

After receiving a New Address message 703 from RAM 106 as mentioned at Sequences 504 and 511 in FIG.5, MTA 107 creates a new socket 706 at Step 705. MTA 107 then instructs IP Routing Module 108 to use the AP Identification for this newly created socket 706 at Step 707, binds the new IP address to this newly created socket 706 at Step 709 then connects to PA 206 at Step 711 to establish the desired IP connection. Procedures for handling incoming and outgoing packets in the IP Routing Module 108 are further described in FIG. 9. Because that the RAM 106 maintains the one-to-one mapping of a particular AP 120 with its AP Identification to a dedicated input-output Buffer 104 in a radio air interface 102, all data read from and written to this socket 706 go through a chosen AP.

Refer to FIG. 8 for the Connection Association procedure 800 used by PA 206 running in PCD 205. PA 206 accepts an IP connection 803 from MTA 107. PA 206 checks if MTA 107 provides an MCI 805. If no MCI is provided, PA 206 creates a MCI for this new IP connection 811 and maintains a record that MAT 107 owns this MCI 813 for this new IP connection. Then, PA 206 sends the MCI to MTA 107 for future use 815. If MAT 107 provides an MCI 805, PA 206 checks if MTA 107 owns this MCI 821. If MTA 107 owns this MCI, PA 206 finds the existing IP connection for the MCI to associate with the new IP connection 823. If MTA 107 does not own this MCI, PA 206 disconnects the new IP connection 825.

Refer to FIG. 9 for AMT related packet handling procedures 900 of IP Routing Module 108. IP Routing Module 108 starts 901, waits for next task 903. If the next task is the instruction sent by MTA 107 at Step 707, IP Routing Module 108 adds the specific socket 706 to the list of sockets associated with the specified AP Identification 911, then, continues to wait for next task 903.

If the next task is to handle an incoming packet, IP Routing Module 108 retrieves the AP Identification that the packet arrives from 921, looks up the socket 706 from the list of sockets associated with said AP Identification using destination IP address and port number contained in the incoming packet 923, delivers the incoming packet to said socket 706 at Step 925, then, continues to wait for next task 903. This procedure uses the additional AP Identification in determining the destination socket and therefore allows different AP to assign the same IP address value to the same MT 200.

If the next task is to handle an outgoing packet, IP Routing Module 108 uses the socket 706 to look up the associated AP Identification 931, sends the outgoing packet through the specific air interface identified by the associated AP Identification 933, then, continues to wait for next task 903. This procedure allows MTA 107 to send data via specific path through the use of the AP Identification.

Thought the term IP connection is used through out this description, the principle of IP connection in this invention is applicable to SCTP, TCP as well as connectionless techniques such as UDP, User Datagram Protocol.

The invention and all of the functional operations described in this specification can be implemented in digital electronic circuitry, or in computer software, firmware or hardware, including the structural means disclosed in this specification and structural equivalents thereof, or in combination of them.

The processes and logic flows described in this specification can be performed by one or more programmable processors executing one or more computer programs to perform functions of the invention. The processes and logic flows can also be performed by, and apparatus of the invention can be implemented as, special purpose logic circuitry, e.g., FPGA (field programmable gate array) or an ASIC (application specific integrated circuit).

The fundamental principles of the implementation of the invention have been described. Nevertheless, it will be understood that various modifications may be made. Accordingly, other implementations are within the scope of the following claims.

What is claimed is:

1. A method for creating an IP socket for exchanging data between a mobile terminal and a peer computing device via one specific air interface in the mobile terminal, the method comprising:
a) upon establishing radio air interface link with an access point and acquiring an IP address from the now associated access point, a radio access manager computer program making available the identification of said associated access point and said IP address to a software application running in said mobile terminal,
b) said software application creating an IP socket using said IP address for exchanging data with a peer application running on said peer computing device,
c) said software application instructing the IP routing module running in said mobile terminal to associate said IP socket with said identification of said associated access point,
d) said IP routing module utilizing said identification of said associated access point in identifying the receiving socket for incoming packets from the radio air interface link associated with said identification of said associated access point,
e) said IP routing module sending outgoing packets from said IP socket through the radio air interface link associated with said identification of said associated access point,

2. A method for managing the transition of IP connections, the method comprising a software application running on a mobile terminal:
a) establishing with a peer application running on a peer computing device a first IP connection, using the IP socket creation method of claim 1, through a first radio access point while in the coverage area of said first radio access point,
b) coordinating with said peer application to use a mobile connection identification to represent the connection between said software application and said peer application,
c) using said first IP connection as an active conduit to exchange data with said peer application,
d) establishing with said peer application a second IP connection, using the IP socket creation method of claim 1, through a second radio access point when roaming into the coverage area of said second radio access point,
e) providing said mobile connection identification for said peer application to associate said first IP connection and said second IP connection,
f) coordinating with said peer computing device to use said second IP connection as the active conduit to exchange data with said peer computing devise,
g) disconnecting said first IP connection before roaming out of the coverage area of said first radio access point.
